(19) United States
(12) Patent Application Publication
(10) Pub. No.: US 2006/0278055 A1
(43) Pub. Date: Dec. 14, 2006

(54) MACHINE TOOL

(75) Inventor: Uwe VORWERK, Herzlake (DE)

Correspondence Address: ROBERTS, MLOTKOWSKI & HOBBES, P. O. BOX 10064, MCLEAN, VA, 22102-8064, US

(73) Assignee: Metabowerke GmbH, Nuertingen (DE)

(21) Appl. No.: 11/383,076

(22) Filed: May 12, 2006

(30) Foreign Application Priority Data
Jun. 14, 2005 (DE) 20 2005 009 377.7

(51) Int. Cl. B23D 19/00; B23D 33/02

(52) U.S. Cl. 83/473

(57) ABSTRACT

A machine tool, especially a band saw, with a support and a machining table which forms a work rest surface and which is supported on the support, the machining table being pivotabe out of a base position around a virtual pivoting axis defined by an arc-shaped link slot in at least one direction, the link slot being provided on the machining table or on the support. The machining table is supported and guided on the support by a bearing means in the radial direction, the bearing means engaging the link slot and being arranged on the support or the machining table, and the machining table being fixed in the axial direction on the support. The bearing means supports and guides the machining table not only in the radial direction on the support, but also fixes the machining table in the axial direction on the support.

### BACKGROUND OF THE INVENTION

1. Field of the Invention

The invention relates to a machine tool with a support and a machining table which forms a work rest surface, which is supported on the support, and which can be pivoted out of a base position around a virtual pivoting axis in at least one direction. In particular, the invention relates to a band saw.

2. Description of Related Art

Machine tools are devices which are used for working of materials, such as, for example, cutting and/or milling of the material to be worked. Special applications of machine tools are woodworking, working of plastics, and metalworking. However, a machine tool can also be used in other applications. Here, a machine tool is especially understood as a band saw.

The band saw underlying this invention (German Patent Application DE 197 53 887 A1) has a support and a machining table which forms a work rest surface and which is supported on the support. The machining table can be pivoted to either side around a virtual pivoting axis out of a base position in which it includes a 90° angle with the saw band. For pivoting, there is a gear connection so that the machining table is pivoted by turning a gear wheel.

The virtual pivoting axis of the machining table runs parallel to the machining direction, therefore the direction of the saw notch in the workpiece. The virtual pivoting axis is formed by an arc-shaped link slot. There is one link slot at a time on one of two opposing supporting members of the machining table.

The virtual pivoting axis, here, and likewise, in the machine tool of the invention defines an axial direction. Lines emerging perpendicular to this axial direction radially from the pivoting axis define the radial direction with reference to the pivoting axis.

The machining table is supported with the two supporting members on the support of the band saw. Here, bearing means engaging the link slot are used for positioning and guiding the machining table in the radial direction. In the axial direction, the machining table is fixed by means of the two supporting members. They extend around the support of the band saw so that axial displacement of the machining table is not possible.

The mounting of the machining table on the support in the above described structure is complex, since support of the machining table in the radial direction and fixing in the axial direction are carried out separately from one another and by different elements. This separation makes it necessary for both the bearing means and the supporting members to be matched exactly to one another in order to ensure reliable support. This increases the production costs of the parts. Furthermore, in is band saw, there is no protection of the guide or the gear connection against contaminants, such as, for example, dirt.

### SUMMARY OF THE INVENTION

A primary object of this invention is to optimize a machine tool of the initially mentioned type with respect to supporting and fixings of the machining table.

The invention achieves the above explained object by a machine tool with a support and a machining table which forms a work rest surface and which is supported on the support, in which the machining table can be pivoted out of a base position around a virtual pivoting axis in at least one direction, the pivoting axis being formed by an arc-shaped link slot, the link slot being provided on the machining table or on the support, the bearing means being provided on the support or on the machining table, the machining table being supported and guided on the support by the bearing means, the bearing means engaging the link slot and guiding the machining table radially relative to the pivot axis, and also fixing the machining table to the support in the axial direction.

Above object is achieved in accordance with the invention, first of all, in that the machining table is supported and guided on the support by one single bearing means, that guides not only in the radial direction, but also in the axial direction. In this way, the number of components is reduced. Moreover, tolerance sensitivity is reduced since fewer components need to be matched to one another. Nevertheless, secure support and guidance of the machining table are ensured.

In one preferred embodiment, the bearing means has an arc-shaped ledge with which it engages the link slot, and a rim which overlaps one section of the link slot. The arc-shaped ledge is used here for support and guidance of the machining table in the radial direction, while the rim is intended for axially fixing the machining table in position.

Furthermore, it is advantageous if there is a mounting plate for the bearing means which is located on the side of the link slot opposite the bearing means. It is used as the counterpart of the bearing means for axially fixing the machining table in position. Preferably, the link slot is provided in a supporting member of the machining table. These components are arranged in the sequence mounting plate, supporting member, bearing means. This arrangement enables an especially compact and stable structure of the entire support and guidance of the machining table.

Another aspect involves arranging the support and guidance of the machining table in a protective housing so that the bearing point of the machining table is protected against contaminants, such as dirt and sawdust. This prevents clogging of the link slot and thus hindrance or blocking of the pivoting motion of the machining table.

The protective housing is especially advantageous when the machining table is supported by the above described bearing means, the mounting plate and the supporting member of the machining table, since a compact arrangement is achieved in which the protective housing can be implemented with relative ease.

In one approach, there is not only one arc-shaped link slot, but two of them. The first link slot is used to guide the pivoting motion and the second link slot is used to fix the machining table in any pivoting position. The two functions of guidance and fixing are therefore decoupled from one another, by which each element can be designed exactly for the function assigned to it. The support and guidance of the machining table are thus optimized overall.

This configuration is especially recommended in conjunction with the use of a protective housing since, in this way, the part which is intended for guiding and radially supporting the machining table can be completely covered by the protective housing without the part which is accessible to the operator for actuation for fixing the machining table in any pivoting position being covered up.

Other details, features, objectives and advantages of this invention are explained in detail below using the drawings of one preferred embodiment.

### BRIEF DESCRIPTION OF THE DRAWINGS

FIG. 1 shows a partially cutaway, elevational side view of a band saw machine,

FIG. 2 is a perspective view of the bearing means from FIG. 1,

FIG. 3 is an extract from FIG. 1 showing the mounting plate,

FIG. 4 is a sectional view through the supporting member of FIG. 1.

### DETAILED DESCRIPTION OF THE INVENTION

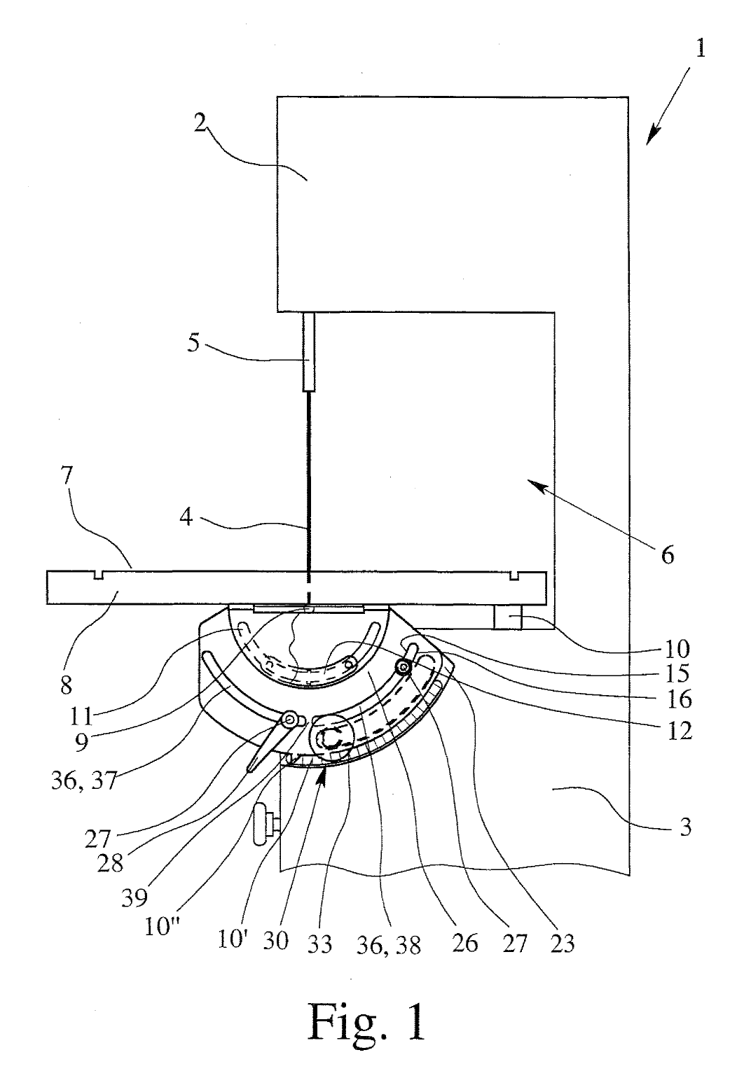

FIG. 1 shows, as an example of a machine tool, a band saw with a C-shaped support 1. The support 1 has an upper section 2 with a deflection wheel in it and a lower section 3, likewise, with a deflection wheel. A saw band 4 equipped with a saw band guide 5 runs around the two deflection wheels.

In the C-opening 6 of the C-shaped support 1, on the lower section 3 of the support 1, a machining table 8 which forms a work rest surface 7 is supported. A workpiece to be cut has to be positioned on the surface 7. The machining table 8 can be pivoted around a virtual pivoting axis 9 in a direction out of a base position in which it is vertically penetrated by the saw band 4. It is also possible that the machining table 8 can be pivoted in the two opposite directions, but here there is preferably only one pivoting direction. In this way, it is possible to allow the machining table 8, in its base position, in addition to a clamping mechanism (see below), to strike a stop 10, and in this way, to impart greater stability to the machining table 8 in this base position. The stop 10 is preferably made elastic, for example, from rubber. An angle scale 10′ and a corresponding pointer 10″ are provided for setting a defined pivoting position.

The virtual pivoting axis 9 defines the axial direction of the machining table 8. Each direction transversely to the axial direction is called the radial direction relative to the pivoting axis 9.

The virtual pivoting axis 9 is defined by an arc-shaped link slot 11. The link slot 11 is provided on the machining table 8 or on the support 1. Here, the link slot 11 is on the part which belongs to the machining table 8.

For support purposes, the machining table 8 is supported and guided in the radial direction on the support 1 by a bearing means 12. The bearing means 12 is located, accordingly, corresponding to the arrangement of the link slot 11 on the support or on the machining table 8, here, therefore, on the support 1.

The bearing means 12 engages the link slot 11 so that the machining table 8 can be moved or pivoted alone the link slot 11. In the axial direction, the machining table 8 is fixed on the support 1. The bearing means 12 is made such that it supports and guides the machining table 8 not only in the radial direction on the support 1, but also fixes it in position in the axial direction on the support 1. The bearing means 12 thus assumes a double function and, aside from a counterpart for axial fixing of the machining table 8, is the only element for supporting the machining table 8. Optionally, it can also be provided that there are two such bearing means 12 opposite one another. The machining table 8 would then be supported more stably, and in any case, installation would be more complex, while such redundant support of the machining table 8 is not necessary.

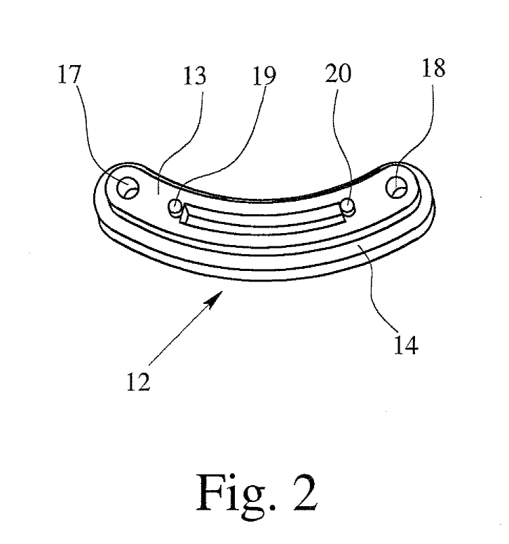

The bearing means 12 has an arc-shaped ledge 13 (FIGS. 1, 2) with which it engages the link slot 11. In addition, the bearing means 12 has a rim 14 which is provided here peripherally around the arc-shaped ledge 13. The rim 14 overlaps two opposing sections 15, 16 of the link slot 11. The arc-shaped ledge 13 of the bearing means 12 is used here for radial guidance and support of the machining table 8 and the rim 14 is used to axially fix the machining table 8 in position. To do this, there is a corresponding counterpart on the side of the link slot 11 opposite the rim 14 (see below). Alternatively to the configuration of the rim 14 described here, it is sufficient if it also overlaps only one section 15 of the link slot 11. To prevent tilting of the arc-shaped outline 13 in the link slot, overlapping of two preferably opposing sections 15, 16 is however preferred.

The bearing means 12 has two screw holes 17, 18 which are spaced apart from one another. They are arranged such that screws which are inserted into the screw holes 17, 18 project through the link slot 11, and accordingly, do not hinder relative motion between the link slot 11 and the bearing means 12. The screws inserted into the screw holes 17, 18 are used to attach the bearing means 12. The screw holes 17, 18 are preferably each located at a respective end of the bearing means 12.

To attach the bearing means 12, there are additionally two pins 19, 20 which are likewise arranged such that they project through the link slot 11. The pins 19, 20 extend into corresponding holes 21, 22 of the support 1 (or a part connected to the support 1) or of the machining table 8.

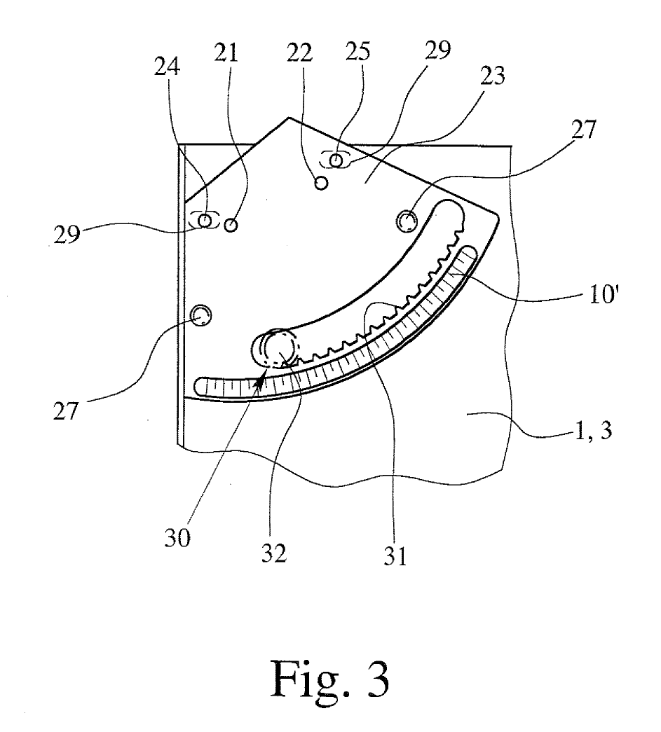

Here, preferably, there is a mounting plate 23 for the bearing means 12 (FIGS. 2, 3) which is rigidly connected to the support 1; here specifically, it is connected to the support 1 by screws. The mounting plate 23 has holes 21, 22 for the pins 19, 20 of the bearing means 12. Furthermore, the mounting plate 23 has holes 24, 25 for the screws which extend through the screw holes 17, 18. The holes 24, 25 can be provided as threaded holes so that the bearing means 12 is screwed to the mounting plate 23. However, here, the holes 24, 25 are made without an internal thread. The mounting plate 23 and the supporting member 12, together, are screwed to the support 1. Consequently, the screws extend through the holes 24, 25 into the support 1 so that the bearing means 12 is also rigidly connected to the support 1.

The machining table 8, itself, has a supporting member 26 which is used for supporting the machining table 8 in conjunction with the bearing means 12. Here, the supporting member 26, preferably, has a link slot 11. In the illustrated embodiment the mounting plate 23 is rigidly connected to the support 1, the bearing means 12 is rigidly connected to the mounting plate 23, and the supporting member 26 is rigidly connected to the machining table 8. These three components are arranged in the sequence mounting plate 23, supporting member 26 and bearing means 12. The arc-shaped ledge 13 of the bearing means 12 extends into the link slot 11. Therefore, the rim 14 overlaps the link slot 11, and thus, is used for axially fixing the supporting member 26 from one side. From the other side the mounting plate 23 adjoins the supporting member 26 as a counterpart. The pins 19, 20 and the screws are used to fix the bearing means 12 in position on the mounting plate 23. The supporting member 26 is thus axially fixed in position and can be moved radially along the link slot 11.

Here, the supporting member 26 is preferably made as a metal casting, for example, as an aluminum casting or as a zinc die casting. The version as a zinc die casting is especially well suited since, in this way, especially great strength can be achieved and correspondingly high forces can be accommodated.

There is at least one clamp element 27 for fixing the machining table 8 in any pivoting position. Here, the clamp element 27 is provided with a clamp lever 28, and another clamp element 27 which is used only, if necessary, however normally acts only as a guide.

To attach the bearing means 12 to the support 1 by means of the mounting plate 23, the support 1 has oblong holes 29. The mounting plate 23 can be moved along the oblong holes 29 on the support 1, and thus, also the machining table 8. The oblong holes 29 are used for simple mounting and optimum alignment of the machining table 8 on the support 1. Depending on the configuration of the support, there can also be oblong holes on the machining table 8. The oblong holes can be provided altogether for mounting the bearing means 12 and/or the link slot 11, and as in the embodiment shown here, also for mounting the mounting plate 23 and/or the supporting member 26.

FIGS. 1 & 3 show a gear connection 30 with which the machining table 8 can be pivoted. The gear connection 30 is formed by an arc-shaped toothed segment 31 and a gear wheel 32 which meshes with it. Here, the gear wheel 32 is preferably supported in the supporting member 26. The toothed segment 31 is located on the support 1, here especially on the mounting plate 23. To pivot the machining table 8 there is a knob 33. By turning the knob 33, the gear wheel 32, which is supported in the supporting member 26, is turned. The gear wheel 32 meshes with the arc-shaped toothed segment 31 so that the supporting member 26 moves relative to the mounting plate 23. The motion is guided by the link slot 11.

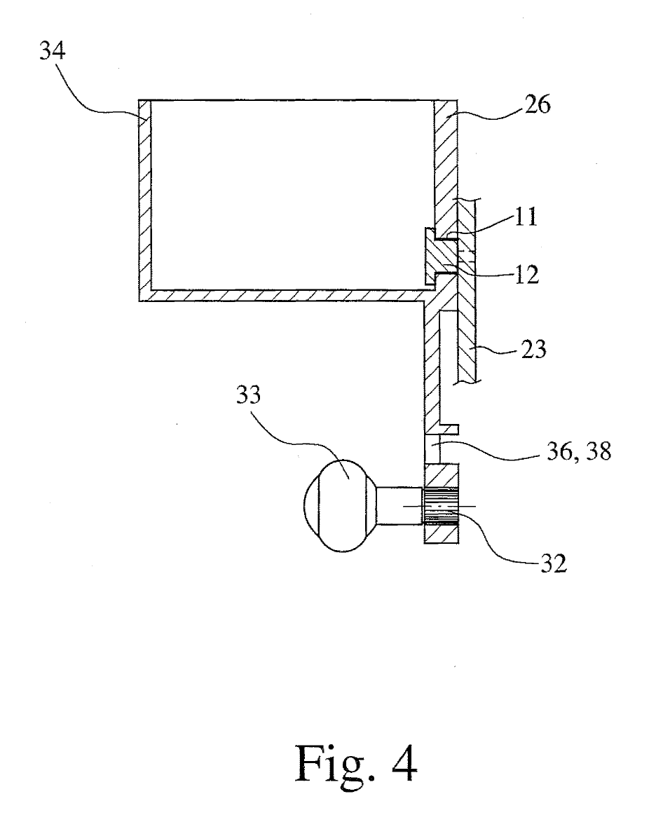

One aspect of the invention is directed to protecting the bearing point of the machining table 8 against fouling by dirt, sawdust, etc. To do this, there is a protective housing 34 located underneath the machining table 8 (FIG. 4). The support and guidance of the machining table 8 are arranged within the protective housing 34 such that the bearing point is protected against dirt. Here, one side wall of the protective housing 34 is preferably not completely closed, but has a link slot 11 which enables guidance of the machining table 8 in the radial direction. Thus it forms the supporting member 26 of the machining table 8.

To pivot the machining table 8, here, there is preferably a gear connection 30. The gear connection 30 is also at least partially covered up by the protective housing 34 (FIG. 1) so that it is also protected against fouling. Fouling at the bearing point of the machining table 8 or on the gear connection 30 can otherwise lead to inhibited pivoting motion of the machining table 8 or even blocking it completely. This would be particularly detrimental in view of the ledge/link-slot arrangement defining a virtual pivoting axis, which is more sensitive to dirt than a normal pivot point.

Here, the protective housing 34 is preferably connected to supporting member 26 of the machining table 8, specifically made integrally with it. The supporting member 26 is also used here to support part of the gear connection 30. To do this, reference is made to the above described configuration of the machine tool.

Another aspect of the invention is directed to separating the guidance of the pivoting motion from the fixing of the machining table 8 in any pivoting position. To do this, there is a first link slot 11 which is used to guide the pivoting motion of the machining table 8, and a second link slot 36 which is used to fix the machining table 8 in any pivoting position. The first link slot 11 for guiding the pivoting motion of the machining table 8 is made preferably according to the preceding description.

To fix the machining table 8 in any pivoting position, there is at least one clamp element 27 which extends through the second link slot 36. The clamp element 27 or the clamp elements 27 are therefore located on the support 1, or here, on the mounting plate 23 and extend through the second link slot 36. From the opposite side, there are a clamp lever 28 on one clamp element 27 and a nut on the other clamp element 27.

Here, the second link slot 36 is preferably arranged concentrically to the first link slot 11. The second link slot 36, like the first link slot 11, has an essentially uniform width. However, when the two link slots 11, 36 are not arranged concentrically to one another, it is necessary for the second link slot 36 to have a relatively great width or a variable width so that the clamp element 27 which extends through the link slot 36 does not block the pivoting motion of the machining table 8.

The first link slot 11 is preferably located above the second link slot 36. This is especially advantageous since the first link slot 11 is better protected against dirt, the nearer it is located to the bottom of the machining table 8. Furthermore, this arrangement is advantageous for reasons of ease of operation since a clamp element 27 located farther down can be reached more easily by the operator.

The second link slot 36 is formed by two areas 37, 38 which are spaced apart from one another. The two areas 37, 38 of the link slot 36 are separated from one another by a crosspiece 39 on opposing ends. The crosspiece 39 is provided for reasons of better strength.

FIG. 4 shows that the two link slots 11, 36 are located in the supporting member 26 of the machining table 8. In particular, the previous description also applies to the supporting member 26. The arrangement of the two link slots 11, 36 in the supporting member 26 is especially advantageous for reasons of a compact arrangement. But alternatively, it can also be provided that one link slot 11; 36 is located in the supporting member 26 of the machining table 8 and the other link slot 36; 11 is located in the support 1 or the mounting plate 23.

What is claimed is:

1. Machine tool with a support and a machining table which forms a work rest surface and which is supported on the support, the machining table being pivotable out of a base position around a virtual pivoting axis in at least one direction,
wherein the pivoting axis, which as such defines an axial direction, is formed by an arc-shaped link slot,
wherein the link slot is provided on one of the machining table and the support,
wherein a bearing means is provided on the other of the machining table and the support,
wherein the machining table is supported and guided on the support by the bearing means,
wherein the bearing means engages the link slot, and
wherein the bearing means guides the machining table radially relative to the pivoting axis, and also fixes the machining table on the support in the axial direction.

2. Machine tool as claimed in claim 1, wherein the bearing means has an arc-shaped ledge with which the bearing means engages the link slot, and wherein the bearing means has a rim which overlaps at least one section of the link slot.

3. Machine tool as claimed in claim 1, wherein the bearing means has rims which overlap two opposing sections of the link slot.

4. Machine tool as claimed in claim 1, wherein the bearing means has two screw holes which are arranged such that screws which are inserted into them project through the link slot.

5. Machine tool as claimed in claim 1, wherein the bearing means has two pins which are arranged such that they project through the link slot in the mounted state and fit into corresponding holes of the other of the support or of the machining table.

6. Machine tool as claimed in claim 1, wherein there is a mounting plate for the bearing means which is rigidly connected to the support.

7. Machine tool as claimed in claim 1, wherein the machining table has a supporting member in which the link slot is provided.

8. Machine tool as claimed in claim 1, wherein the machining table has a supporting member which is formed as a metal casting.

9. Machine tool as claimed in claim 7, wherein the mounting plate is rigidly connected to the support and the bearing means is rigidly connected to the mounting plate, wherein the supporting member is rigidly connected to the machining table, and the bearing means, mounting plate and supporting member are arranged in the sequence mounting plate, supporting member and bearing means.

10. Machine tool as claimed in claim 1, wherein there is at least one clamp element with which the machining table can be fixed in any pivoting position.

11. Machine tool as claimed in claim 1, wherein there are oblong holes on at least one of the support and the machining table for mounting of at least one of the bearing means and the link slot.

12. Machine tool as claimed in claim 1, wherein there is a gear connection with which the machining table can be pivoted.

13. Machine tool as claimed in claim 12, wherein the gear connection is formed by an arc-shaped toothed segment and a gear wheel which meshes with it.

14. Machine tool as claimed in claim 13, wherein the gear wheel is supported in the supporting member and wherein the toothed segment is located on the support.

15. Machine tool as claimed in claim 1, wherein a protective housing is provided underneath the machining table and
wherein the means for supporting and guiding the machining table are arranged within the protective housing such that a bearing point or bearing points thereof is/are protected against dirt.

16. Machine tool as claimed in claim 15, wherein a gear connection is provided with which the machining table is pivotable, and wherein the gear connection is at least partially covered by the protective housing.

17. Machine tool as claimed in claim 15, wherein the protective housing is connected to the supporting member of the machining table.

18. Machine tool as claimed in claim 17, wherein the protective housing is integral with the supporting member.

19. Machine tool as claimed in claim 1, wherein a second arc-shaped link slot is provided, and wherein the first link slot guides the pivoting motion and the second link slot is for fixing the machining table in any pivoting position.

20. Machine tool as claimed in claim 19, wherein at least one clamp element extends through the second link slot.

21. Machine tool as claimed in claim 19, wherein the second link slot is arranged concentrically to the first link slot.

22. Machine tool as claimed in claim 21, wherein the first link slot is located above the second link slot.

23. Machine tool as claimed in claim 19, wherein the two link slots are located in a supporting member of the machining table.

24. Machine tool as claimed in claim 19, wherein one of the link slots is located in a supporting member of the machining table and the other of the link slots is located in the support.

25. Machine tool as claimed in claim 1, fierier comprising a saw band extending between upper and lower sections of the support.
